(19) United States
(12) Patent Application Publication
(10) Pub. No.: US 2006/0267413 A1
(43) Pub. Date: Nov. 30, 2006

(54) AC line voltage measuring system for a switch mode flyback power supply

(75) Inventors: Perry Rothenbaum, St. Charles, IL (US); Bernardo Figueiredo, Geneva, IL (US); Mark Fischer, Elgin, IL (US)

Correspondence Address: Harness, Dickey and Pierce, PO Box 828, Bloomfield Hills, MI, 48303, US

(73) Assignee: Emerson Electric Co., St. Louis, MO (US)

(21) Appl. No.: 11/132,668

(22) Filed: May 19, 2005

(51) Int. Cl. H02J 7/00; H01H 47/00

(52) U.S. Cl. 307/125

(57) ABSTRACT

A method and a system for determining an AC input voltage in an output side of an isolated switching power supply are disclosed. The invention detects a peak-to-peak voltage in the output side of the power supply at a point in a circuit topology of the output side where the peak-to-peak voltage correlates to the AC input voltage. The AC input voltage is determined from the detected peak-to-peak voltage.

### FIELD OF THE INVENTION

The present invention relates generally to a method and a system for determining an AC input voltage using a peak-to-peak voltage detected on an isolated side of a switching power supply.

### BACKGROUND OF THE INVENTION

A switching power supply is generally known in the art. The term “switching power supply” is derived from using a switch in a circuit topology of the power supply that controls the amount of power delivered to the circuit's load. Vast arrays of electronic applications utilize switching power supplies in order to make use of an AC input voltage from a wall socket outlet. However, many of today's electronic applications require a conversion of the AC input voltage, a 110 V, 60 Hz conventional low frequency sinusoidal AC power source from a standard United States outlet socket into a desired DC voltage, current and/or waveform needed by a specific application. In addition, a switching circuit topology may incorporate a transformer, an inductor or a combination of both to employ one of several well-known circuits: buck, boost, buck-boost, forward, half bridge, full bridge or flyback to convert AC input voltage into a required power needed by the specific application.

FIG. 1 depicts an AC power source 5, such as a 110 V, 60 Hz standard outlet used in the United States, any standard outlet used in a foreign country, or any other power source, coupled to a conventional switching flyback power supply 10. The switching flyback power supply 10 includes an AC filter 11, a full or half bridge rectifier circuit 12, a capacitor 13, a flyback transformer 14, a diode 16, a capacitor 18 and a switch 19. The AC power source 5 is coupled to the AC filter 11. The AC filter 11 is coupled to the bridge rectifier circuit 12. The bridge rectifier circuit 12 is coupled to one side of the capacitor 13. Additionally, the one side of the capacitor 13 is coupled to an input to the flyback transformer 14. The flyback transformer 14 contains a set of coils, primary windings 20 and secondary windings 22, formed around a core (not shown). The one side of the capacitor 13 is coupled to one side of primary windings 20 of the flyback transformer 14. The other side of the primary windings 20 is coupled to one side of the switch 19. The other side of the switch 19 is coupled to the other side of the capacitor 13. The other side of the capacitor 13 is coupled to the other side of the bridge rectifier circuit 12. One side of the secondary windings 22 of the flyback transformer 14 is coupled to an anode terminal of the diode 16. A cathode terminal of the diode 16 is coupled to a positive side of the capacitor 18. A negative side of the capacitor 18 is coupled to the other side of the secondary windings 22.

In operation, the AC power source 5 outputs an AC input voltage to the power supply 10. The AC filter 11 eliminates fluctuations going to and from the AC input voltage and sends the AC input voltage to the bridge rectifier circuit 12. The bridge rectifier circuit 12 is a full-wave rectifier consisting of diodes arranged in a four-cornered configuration. The bridge rectifier circuit 12 converts the AC input voltage into a positive DC voltage. After receiving the positive DC voltage, the capacitor 13 transforms the positive DC voltage into a nearly-constant-level DC voltage. The constant-level DC voltage is applied to the flyback transformer 14 in voltage pulses via opening and closing the switch 19. The operation of the flyback transformer 14 occurs in two states of a cycle of opening and closing the switch 19, commonly referred to as a charging and a discharging stage. The cycle of opening and closing the switch 19 controls an amount of power delivered to the flyback transformer 14, as well as an amount of power applied to a load of the flyback transformer 14. A closed switch 19 is indicative of an “ON” time or the charging stage. An opened switch 19 is indicative of an “OFF” time or the discharging stage. The cycle of “ON” to “OFF” time chops a constant-level DC voltage into pulses which results in current pulses through the transformer 14; hence, a current pulse is applied to the flyback transformer 14.

During the charging stage of the cycle, the current pulse is applied to the flyback transformer 14. Unlike a typical transformer that directly transfers energy from the primary windings 20 to the secondary windings 22, the flyback transformer 14 draws a current in the primary windings 20 and stores energy in the core. The core contains discrete air gaps or a distributed gap that stores energy. As the energy is stored in the gap of the core, a magnetic field is formed. On an isolated side of the transformer 14, the diode 16 blocks current flow from the flyback transformer 14 to the capacitor 18. Energy is stored in the core until a change in the polarity of the voltage occurs causing, the magnetic field of the core to collapse.

Once switch 19 is opened, the polarity of the voltage changes and the discharging stage begins. The current that formed and maintained the core's magnetic field during the charging stage becomes zero, causing the core's magnetic field to collapse. The collapse of the core's magnetic field causes a negative flux change and induces a high voltage reversal to occur in the flyback transformer 14. The high voltage is called an inductive kickback voltage, also known as a flyback voltage. The flyback transformer 14 discharges a leakage inductance, energy stored in the air gap and resets the magnetic field in the core. Due to a change in the voltage's polarity, current flows through the diode 16 and charges the capacitor 18. The flyback transformer 14 continues to discharge current into the capacitor 18 until either the magnetic field completely dissipates or the switch 19 closes once again. After the switch 19 closes, the polarity of the voltage reverses; thus, the cycle begins again.

In order to detect variations in an AC input voltage applied to input side of an isolated switching power supply, a method and a system are needed to correlate an output voltage in an output side of the isolated switching power supply (e.g. a secondary side of a flyback transformer) to the AC input voltage. By detecting the variations in the AC input line voltage, systems may minimize conditions that may harm an overall system functionality, such as locked rotor conditions due to the AC input voltage falls to low, mis-wire and over-voltage conditions due to the AC input voltage rises to high.

### SUMMARY OF THE INVENTION

In accordance with an aspect of the invention, a method and a system are provided for determining an AC input voltage in an output side of an isolated switching power supply. The method includes detecting a peak-to-peak voltage in the output side of the power supply at a point in a circuit topology of the output side where the peak-to-peak voltage correlates to the AC input voltage. The AC input voltage is determined from the detected peak-to-peak voltage.

The system implementing the method for determining the AC input voltage includes an AC power source, an isolated switching power supply, a conversion module and a sampling module. The AC power source is coupled to the power supply. The power supply is coupled to the conversion module. The conversion module is coupled to the sampling module.

The AC power source supplies an AC input voltage to an input side of the power supply. The power supply transforms the AC input voltage into a correlated peak-to-peak voltage. The conversion module detects the peak-to-peak voltage in an output side of the power supply at a point in a circuit topology of the output side where the peak-to-peak voltage correlates to the AC input voltage. After the peak-to-peak voltage is detected, the sampling module determines the AC input voltage based on the peak-to-peak voltage.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a circuit diagram of a conventional isolated switching power supply coupled to a 110 V, 60 Hz standard outlet;

FIG. 2 is a graphical representation of exemplary AC input voltages compared to measured voltage outputs in an isolated side of a flyback transformer;

FIG. 3 is a flow diagram describing a method for determining an AC input voltage in an isolated switching power supply;

FIG. 4 is a schematic block diagram showing a system according to the invention for implementing a method for determining an AC input voltage using a peak-to-peak voltage detected in an output side of an isolated switching power supply;

FIG. 5 is a block diagram depicting a preferred embodiment of a conversion module for transforming a peak-to-peak voltage into a constant-positive DC voltage;

FIG. 6 is a schematic representation of an exemplary circuit implementation of the preferred embodiment of the conversion module of the invention; and

FIG. 7 is a schematic representation of an exemplary circuit implementation of an alternative embodiment of the conversion module of the invention.

### DETAILED DESCRIPTION OF THE PREFERRED EMBODIMENTS

The following description of the preferred embodiment(s) is merely exemplary in nature and is in no way intended to limit the invention, its application or uses.

The invention described herein addresses a need to monitor an AC input voltage in an isolated side of the power supply where the AC input voltage is applied to an input side of the switching power supply. Monitoring the AC input voltage on the isolated side of the power supply provides a low cost and efficient method and system to protect appliances and/or circuits requiring a conversion of a 110 V, 60 Hz standard outlet from power surges, opens or short circuits and mis-wirings of power terminals to the power supply during a manufacturing or installation process. Additionally, the invention detects a low or high AC input voltage that may adversely affect other components or subsystems in a system. Moreover, the invention collects statistical data of voltage levels regarding the AC input voltage seen in the life of an appliance that may be used for product enhancements. Furthermore, the invention determines and records an amount of time a control will remain self-powered, if an AC input voltage outage occurs.

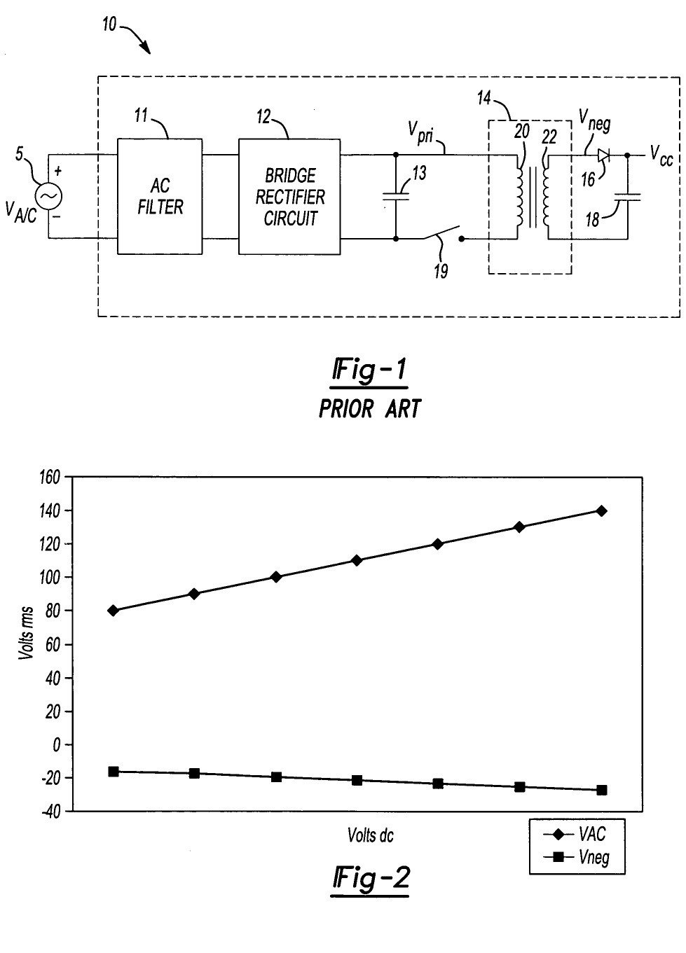

Some aspects of this invention utilize specific parameters of a conventional switching flyback power supply 10, as shown in FIG. 1. The specific parameters of the power supply 10 are an inductive kickback voltage, V_{Neg}, discharged from the flyback transformer 14 and a positive output voltage relating to a capacitor 18, V_{Pos}. In order to further understand the present invention, the following equations are presented to show how V_{Neg} and V_{Pos} are computed and obtained. In designing the transformer 14 of the power supply 10, a well-known equation is used:

$$\frac{{V}_{Sec}}{{V}_{Pri}} = ( \frac{\# of Secondary Turns}{\# of Primary Turns} ) \qquad ( Equation 1 )$$

where V_{sec} is a voltage output from the secondary windings 22 and V_{Pri} is a voltage applied to the primary windings 20. This relationship can be expressed as in equation 2:

$${V}_{Sec} = {V}_{Pri} ( \frac{\# of Secondary Turns}{\# of Primary Turns} ) \qquad ( Equation 2 )$$

The output voltage of the secondary windings 22 of the flyback transformer 14 is the inductive kickback, V_{Neg}. V_{Neg}, therefore, may be substituted for V_{sec} in equation 2, as shown in equation 3:

$$\vert {V}_{Neg} \vert = {V}_{Pri} ( \frac{\# of Secondary Turns}{\# of Primary Turns} ) \qquad ( Equation 3 )$$

Next, in order to calculate a voltage applied to primary windings 20 of the flyback transformer 14, V_{Pri}, voltage drops across the AC filter 11 and the bridge rectifier circuit 12 are taken into consideration. To determine V_{Pri}, voltage drops across the AC filter 11 and the bridge rectifier circuit 12 are subtracted from the AC input voltage, V_{ACRMS} as shown in equation 4.
V_{Pri}=V_{ACRMS}−V_{dropACFilter}−V_{dropBridgeRectifier} (Equation 4)
where V_{dropACFiler} denotes a voltage drop across the AC filter 11 and V_{dropBridgeRectifier} denotes a voltage drop across the bridge rectifier circuit 12.

By substituting for V_{Pri} in equation 3 with its equivalent shown in equation 4, equation 5 is derived:

$$\vert {V}_{Neg} \vert = ( {V}_{ACRMS} - {V}_{dropACFilter} - {V}_{dropBridgeRectifier} ) ( \frac{\# of Secondary Turns}{\# of Primary Turns} ) \qquad ( Equation 5 )$$

Chart 1 provides a comparison of exemplary AC input voltages, V_{ACRMS}, to a calculated and a measured flyback voltage, V_{Neg}, based on the above equations.

CHART 1

| V_{ACRMS} | Measured V_{Neg} (V) | Calculated V_{Neg} (V) |
|---|---|---|
| 80 | −15.9 | −15.97 |
| 90 | −17.2 | −18.01 |
| 100 | −19.4 | −20.07 |
| 110 | −21.0 | −22.12 |
| 120 | −23.0 | −24.17 |
| 130 | −25.1 | −26.22 |
| 140 | −27.0 | −28.27 |

Using the above values in Chart 1, FIG. 2 provides a graphical representation of the comparison of V_{ACRMS} to the measured flyback voltage, V_{Neg}.

Next, the positive output voltage related to the capacitor 18, V_{Pos}, is calculated. As the flyback transformer 14 discharges energy, current flows through the diode 16 and charges the capacitor 18. .As the capacitor 18 (V_{CC}) charges, the diode 16 drops a forward voltage drop, V_{dropdiode16}. Thus, V_{Pos} is computed as shown in equation 6:
‘V_{Pos}|=V_{CC}+V_{dropdiode16} (Equation 6)
where V_{CC} is a voltage output by the capacitor 18 and V_{dropdiode16} is the forward voltage drop across the diode 16.

This invention utilizes the inductive kickback voltage, V_{Neg}, and the positive output voltage V_{CC} relating to the capacitor 18, to form V_{Pos}, in a parameter called a peak-to-peak voltage. The following equation illustrates this relationship:
Vₚ₋ₚ=|V_{Pos}|+V_{Neg}| (Equation 7)
Thus, the peak-to-peak voltage, V_{P-P}, is detected in the isolated side of the switching flyback power supply 10.

FIG. 3 illustrates a method 50 for determining an AC input voltage in an output side in an isolated switching power supply. The method 50 begins by detecting the peak-to-peak voltage in an output side of the power supply at a point in a circuit topology where the peak-to-peak voltage correlates to the AC input voltage applied to the power supply, at step 52. The peak-to-peak voltage comprises a negative pulse and a positive voltage pulse. The negative and positive pulses of the peak-to-peak voltage are combined to form a positive DC voltage pulse at step 54. Upon a formation of the positive DC voltage pulse, the positive DC voltage pulse is reduced and scaled into a reduced-positive DC voltage pulse using a voltage divider circuit at step 56. The reduced-positive DC voltage pulse is proportional to the AC input voltage applied to an input side of the power supply. Next, the reduced-positive DC voltage pulse is converted into a constant-positive DC voltage at step 58. After converting the reduced-positive DC voltage pulse, the constant-positive DC voltage is measured at step 60. Once the constant-positive DC voltage is measured, the AC input voltage is determined based on the-constant-positive DC voltage at step 62.

Referring to FIG. 4, an exemplary system 100 for implementing the method 50 is further described. The system 100 includes an AC power source 102, an isolated switching power supply 10, a conversion module 104, a sampling module 106 and an operating module 108. The AC power source 102, such as a 110 V, 60 Hz standard outlet, is coupled to the isolated switching power supply 10. The flyback switching power supply 10 includes a flyback circuit (such as a flyback transformer 14 shown in FIG. 1). The power supply 10 is coupled to the conversion module 104. The conversion module 104 is coupled to the sampling module 106, which may comprise, for example, a microcontroller.

As used in this description, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

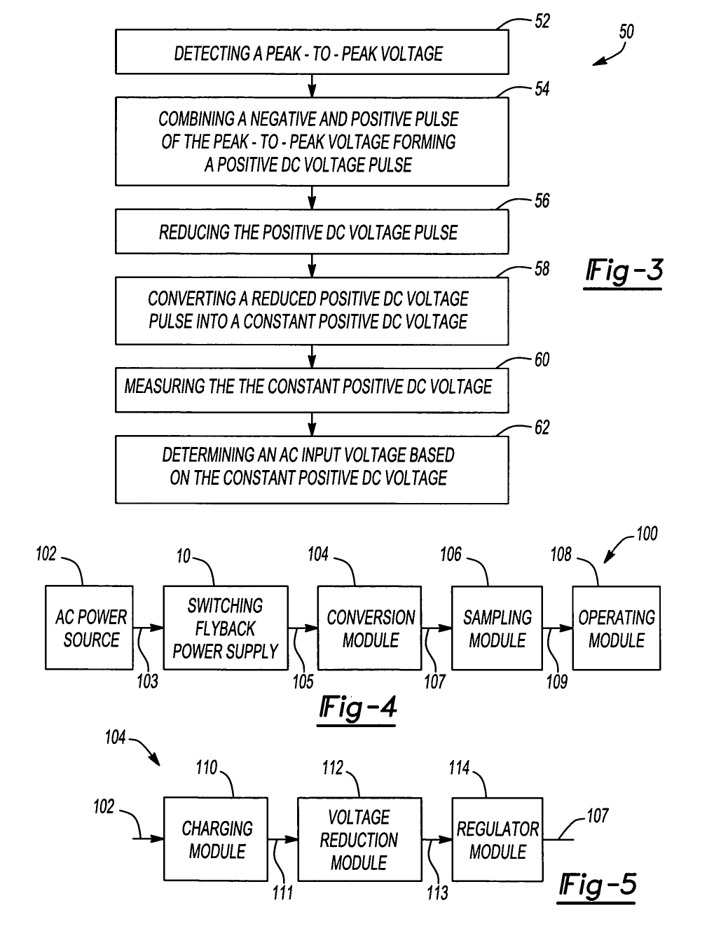

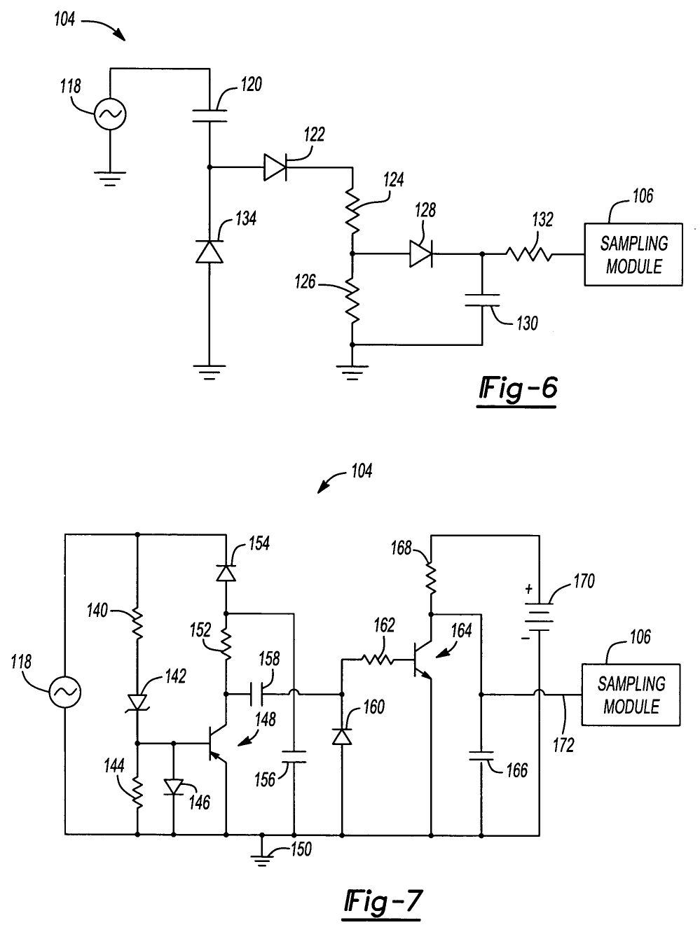

The AC power source 102 sends an AC input voltage 103 to the power supply 10. Upon receipt of the AC input voltage 103, the power supply 10 produces a peak-to-peak voltage 105, which is sent to the conversion module 104. The conversion module 104 detects and transforms the peak-to-peak voltage 105 into a constant-positive DC voltage 107 that is proportional to the AC input voltage 103 applied to an input side of the power supply 10. Referring to FIG. 5, a preferred arrangement of a conversion module 104 comprises a charging module 110, a voltage reduction module 112 and a regulator module 114. The power supply 10 is coupled to charging module 110. The charging module 110 is coupled to the voltage reduction module 112. The voltage reduction module 112 is coupled to the regulator module. 114. The regulation module 114 is coupled to the sampling module 106. The sampling module is in turn coupled to the operating module 108.

As the peak-to-peak voltage 105 is detected, the charging module 110 combines the negative and positive pulses to form a positive DC voltage pulse 111. The charging module 110 sends the positive DC voltage pulse to the voltage reduction module 112.

Upon receipt of the positive DC voltage pulse 111, the voltage reduction module 112 scales the positive DC voltage pulse 111 into a reduced-positive DC voltage pulse 113. The voltage reduction module 112 scales the reduced-positive DC voltage pulse 113 to an acceptable voltage level such that the reduced-positive DC voltage pulse 113 may be measured and/or detected by the sampling module 106 through a general digital I/O port and/or any analog or digital detecting circuit. The reduced-positive DC voltage pulse 113 is proportional to the AC input voltage 103, V_{ACRMS}, applied to the input side of the power supply 10. The voltage reduction module 112 then sends the reduced DC positive voltage pulse 113 to the regulator module 114.

At the regulator module 114, the reduced-positive DC voltage pulse 113 is converted into the constant-positive DC voltage 107. The regulator module 114 holds and maintains the reduced-positive DC voltage pulse 113, such that the reduced-positive DC voltage pulse 113 is transformed into the constant-positive DC voltage 107. In order to maintain the constant-positive DC voltage 107, the regulator module 114 stores and releases the reduced-positive DC voltage pulse 113 to the sampling module 106. While releasing the reduced-positive DC voltage pulse 113, the regulator module 114 blocks current from returning to the voltage reduction module 112. Additionally, the regulator module 114 reduces fluctuations in the constant-positive DC voltage 107.

The sampling module 106 measures the constant-positive DC voltage 107. Prior to measuring the constant-positive DC voltage 107, however, the sampling module 106 discharges the regulator module 114 by turning the general digital I/O port into an output that sinks current to ground. The sampling module 106 then multiples the constant-positive DC voltage 107 by a predetermined factor in order to determine the AC input voltage 103, V_{ACRMS}, applied to the input side of the power supply 10. The sampling module 106 is calibrated to determine instances where the peak-to-peak voltage does not correlate to an AC input voltage within an acceptable range. If the sampling module 106 computes an out of range AC input voltage, the sampling module 106 sets an indicator 109, such as setting a flag as a signal, to notify a user of a trouble condition. Additionally, the sampling module 106 sends the indicator 109 and/or a computed AC input voltage 109 to the operating module 108 to take a predetermined action.

Upon receiving the indication 109 and/or the computed AC input voltage 109, the operating module 108 is operative to store and retrieve statistical data regarding the computed AC input voltage 109 seen in the life of the appliance that may be used for product enhancements and diagnostic purposes. Statistical data includes, but is not limited to, the computed AC input voltage 109 along a time of entry of each occurrence, a rate of change from a previously stored AC input voltage to a newly computed AC input voltage 109, low-voltage occurrences along with a time entry of each occurrence, over-voltage occurrences along with a time entry of each occurrence, and power-outage occurrences along with a time entry of each occurrence. The operational module may shut down a system, a subsystem or a component in order to minimize harm or damage to the system, the subsystem or the component, due to the computed AC input voltage 109 being too high or too low (e.g. turn “OFF” motor due to low voltage conditions). Furthermore, the operating module determines and stores data regarding an amount of time a control will remain self-powered, if a power outage occurs.

FIG. 6 shows an exemplary circuit schematic of the conversion module 104 used in the system 100 for determining the AC input voltage in the isolated side of the transformer 14. A peak-to-peak voltage source 118 is coupled to one side of a first capacitor 120. The peak-to-peak voltage source 118 is the secondary output 22 of the power supply 10 where the AC input voltage is a voltage received from the AC power source 102. The other side of the first capacitor 120 is coupled to an anode terminal of a first diode 122. A cathode terminal of the first diode 122 is coupled to one side of a first resistor 124. The other side of the first resistor 124 is coupled to one side of a second resistor 126. Additionally, the other side of the first resistor 124 is coupled to an anode terminal of a second diode 128. The cathode terminal of the second diode 128 is coupled to one side of a second capacitor 130. The other side of the second capacitor 130 is coupled to the other side of the second resistor 126, which is also coupled to ground. Additionally, the one side of the second capacitor 130 is coupled to one side of a third resistor 132, where the one side of the third resistor 132 is also coupled to the cathode terminal of the second diode 128. The other side of the third resistor 132 is coupled to the sampling module 106, such as a microcontroller. Additionally, the cathode terminal of a third diode 134 is coupled to the other side of the first capacitor 120. An anode terminal of the third diode 134 is coupled to ground.

Using the circuit diagram in FIG. 6, the constant positive DC voltage, V_{Out}, may be calculated using equation 8:

$${V}_{Out} = [ [ \vert {V}_{p - p} \vert - {V}_{dropdiode 122} ] \frac{{R}_{2}}{{R}_{1} + {R}_{2}} ] - {V}_{dropdiode 132} \qquad ( Equation 8 )$$

where Vₚ₋ₚ is the peak-to-peak voltage, V_{dropdiode122} is a voltage drop across the first diode 122, and V_{dropdiode132} is a voltage drop across the second diode 128. Additionally, R₁ is a value for the first resistor 124, and R₂ is a value for the second resistor 126.

In operation, the first capacitor 120 charges from the negative pulse, V_{Neg}, of the peak-to-peak voltage, V_{P-P}, through the third diode 134. As the peak-to-peak voltage initially becomes negative, the third diode 134 is forward-biased and the first diode 122 is reversed-biased, allowing the first capacitor 120 to charge to near the peak of the negative pulse, V_{Neg}. However, as the peak-to-peak voltage, V_{P-P}, passes the peak of the negative pulse, V_{Neg}, the third diode 134 becomes reversed-biased or OFF because the cathode of the third diode 134 is held near the peak voltage of V_{Neg} by the charge of the first capacitor 120. Additionally, the first capacitor does not discharge since the first diode 122 remains reversed-based or “OFF” during the negative pulse, V_{Neg}. Therefore, the first capacitor 120 retains a charge approximately equal to the negative pulse less a voltage drop across the third diode 134.

As the peak-to-peak voltage, V_{P-P}, cycles to the positive pulse, V_{Pos}, a stored charge on the first capacitor 120 is added to the positive pulse, V_{Pos}. The first capacitor 120 behaves essentially like a battery in series with the peak-to-peak voltage, V_{P-P}. Now, the first diode 122 becomes forward-biased or “ON” and the third diode 134 remains reversed-biased or “OFF”; hence, the first capacitor 120 no longer references ground through the third diode 134. However, the first capacitor 120 references ground through the peak-to-peak voltage source. By referencing ground through the peak-to-peak source, the stored charge on the first capacitor 120 is added to the positive pulse, V_{Pos}. The first capacitor 120 slightly charges on the positive pulse, V_{Pos} of the peak-to-peak voltage, V_{P-P}; however, a positive charge is negligible, since, a switching time period of the switch 19 is much smaller than a charging time constant of the first capacitor 120. The charging time constant is an amount of time required for the first capacitor 120 to charge. In general, a charging time constant of a series RC circuit is a time interval that equals a product of a resistance and a capacitance, as shown in equation 9:
τ=RC (Equation 9)
where τ denotes the time constant, C denotes a capacitance value and R is the total resistance in series with C. Hence, the charging time constant of the first capacitor 120 of FIG. 6 is defined as shown in equation 10.
τ=(R₁₂₄+R₁₂₆)·C₁₂₀ (Equation 10)
where R₁₂₄ is a resistance value of the first resistor 124, R₁₂₆ is a resistance value of the second resistor 126 and C₁₂₆ is a capacitance value for the first capacitor 120. Any charging of the first capacitor 120 during the positive pulse, V_{Pos}, of the peak-to-peak voltage, V_{P-P}, only contributes error. Additionally, the switching time period of switch 19 is indicative of combining an “ON” to “OFF” time of switch 19 in FIG. 1. Thus, the switching time period of switch 19, must be significantly smaller than the charging time constant. As a result, the negative pulse and positive pulse are combined to form a positive DC voltage pulse across the first resistor 124 and the second resistor 126.

Furthermore, during the positive pulse, V_{Pos}, of the peak-to-peak voltage, the first diode 122 becomes forward-biased or ON and the positive DC voltage pulse is formed across through the first resistor 124 and the second resistor 126. The first resistor 124 combines with the second resistor 126 to form a voltage divider circuit. The voltage divider circuit reduces the positive DC voltage pulse into a reduced-positive DC voltage pulse. The reduced-positive DC voltage pulse is scaled proportional to the AC input voltage applied to the input side of the power supply 10. The reduced-positive DC pulse travels through the second diode 128 and charges the second capacitor 130. The, second capacitor 130 transforms the reduced-positive DC voltage pulse into a near constant-positive DC voltage. As the second capacitor 130 charges from the reduced-positive DC pulse, the reduced-positive DC pulse is maintained and transformed into a near constant-positive DC voltage. Additionally, the second diode 128 blocks the discharge of the second capacitor 130 during the negative pulse, V_{Neg}, of the peak-to-peak voltage, Vₚ₋ₚ.

The sampling module 106 discharges the second capacitor 130 through the third resistor 132 by turning the general digital I/O port of the sampling module 106 into an output that sinks current to ground. After discharging the second capacitor 130, the sampling module 106 waits for the second capacitor 130 to recharge to a new value and then measures a new constant-positive DC voltage. The sampling module 106 multiples the new constant-positive DC voltage by a predetermined factor to determine the AC input voltage, V_{ACRMS}, applied to the power supply 10.

In order to obtain a greater understanding regarding the detailed circuit in FIG. 6 of the preferred embodiment of the conversion module 104, the following exemplary element values are provided in Chart 2; however, the element values can be changed to more convenient values by the method of scaling.

CHART 2

| Elements | Value | |
|---|---|---|
| First capacitor 120 | 0.1 | μF |
| Second capacitor 130 | 0.001 | μF |
| First resistor 124 | 62 | kΩ |
| Second resistor 126 | 15 | kΩ |
| Third resistor 132 | 15 | kΩ |

Additionally, the Chart 3 displays exemplary constant-positive DC voltages when using the above exemplary element values based on exemplary AC input voltages listed in Chart 1.

CHART 3

| | Measured | Computed | |
|---|---|---|---|
| V_{P—P} (v) | V_{Out} (v) | V_{Out} (v) | % difference |
| 22.2 | 3.584 | 3.575 | 0.2 |
| 17.8 | 2.783 | 2.73 | 1.8 |
| 17.4 | 2.676 | 2.65 | 0.8 |
| 14.0 | 2.059 | 2.0 | 2.8 |
| 11.6 | 1.597 | 1.57 | 3.5 |
| 11.4 | 1.538 | 1.503 | 2.3 |

In an alternative embodiment of the conversion module 104 (FIG. 7), the conversion module 104 detects the peak-to-peak voltage in the output side of the power supply 10. More specifically, the conversion module 104 determines whether the peak-to-peak voltage below a predetermined threshold, where the threshold is indicative of a trouble condition relating to the power supply 10.

In operation, the power supply 10 produces the peak-to-peak voltage. The conversion module 104 detects whether the peak-to-peak voltage is below the predetermined threshold. If the conversion module detects the peak-to-peak voltage is below the threshold, the conversion module 104 sends the sampling module 106 a constant-positive DC voltage. The constant-positive DC voltage is scaled such that the voltage may be received by an input terminal of the sampling module 106. The constant-positive DC voltage is indicative of a non-trouble condition relating to the power supply 10. Additionally, while the conversion module detects the peak-to-peak voltage above the threshold, the conversion module 104 sinks the constant-positive DC voltage to ground, such that the sampling module 106 receives a low signal indicative of a trouble condition relating to the power supply 10.

FIG. 7 provides a schematic of an alternative embodiment of the conversion module 104. As shown in FIG. 7, a peak-to-peak voltage source 118 is coupled to one side of a first resistor 140. An anode terminal of a zener diode 142 is coupled to the other side of the first resistor 140. A cathode terminal of the zener diode 142 is coupled to one side of a second resistor 144. An anode terminal of a first diode 146 is coupled to the one side of the second resistor 144 and the cathode terminal of the zener diode 142. In addition, the anode terminal of the first diode 146 is coupled to a base terminal of a first transistor 148. The other side of the second resistor 144, a cathode terminal of the first diode 146 and an emitter terminal of the first transistor 148 are coupled to ground 150. A collector terminal of the first transistor 148 is coupled to one side of a third resistor 152. The other side of the third resistor 152 is coupled to an anode terminal of a second diode 154. A cathode terminal of the second diode 154 is coupled to the peak-to-peak voltage source 118. The anode terminal of the second diode 154 and the other side of the third resistor 152 are coupled to one side of a first capacitor 156. The other side of the first capacitor 156 is coupled to ground 150. One side of a second capacitor 158 is coupled to the collector terminal of the first transistor 148. The other side of the second capacitor 158 is coupled to a cathode terminal of a third diode 160 and one side of a fourth resistor 162. An anode terminal of the third diode 160 is coupled to ground 150. The other side of the fourth resistor 162 is coupled to a base terminal of a second transistor 164. An emitter terminal of the second transistor 164 is coupled to ground 150. A collector terminal of the second transistor 164 is coupled to one side of a third capacitor 166. The collector terminal of the second transistor 164 is also coupled to one side of a fifth resistor 168. The other side of the fifth resistor 168 is coupled to a positive terminal of a DC power supply 170. A negative terminal of the DC power supply 170 is coupled to ground 150. In addition, the other side of the third capacitor 166 is coupled to ground 150. The collector of the second transistor 164 is coupled to an input terminal of the sampling module 106, such as a general digital I/O port of the microcontroller.

In operation, the DC power supply 170 sends a constant DC positive voltage 107 to the sampling module 106 through the fifth resistor 168. Once detected, the peak-to-peak voltage 105 travels through the first resistor 140 to the zener diode 142. When the peak-to-peak voltage 105 exceeds a predetermined threshold, the zener diode 142 draws current through an emitter base junction of the first transistor 148. The predetermined threshold and the zener diode 142 diode selection are selected based on the applications requirements for a specific AC line voltage to be detected. Once current is drawn through the emitter base junction of the first transistor 148, the first transistor 148 turns “ON” and sends an output signal to the second transistor 164, through the fourth resistor 162. The second transistor 164 is turned “ON” providing a path through the fifth resistor 168 to sink the constant positive DC voltage 107 from the DC power supply 170 to ground 150. Once the sampling module 106 receives a low or zero voltage, the sampling module 106 sets an indication to notify a user of a trouble condition relating to the AC input voltage 103. On the other hand, if the peak-to-peak voltage 105 is below the predetermined threshold, the first transistor 148 remains “OFF;” hence, the second transistor 164 remains “OFF” and the sampling module 106 receives the constant positive DC voltage 107.

In order to provide further understanding of the alternative embodiment of the alternative conversion module 104, the following list of exemplary element values is provided.

CHART 4

| Elements | Value | |
|---|---|---|
| First resistor 140 | 10 | kΩ |
| Second resistor 144 | 1 | kΩ |
| Third resistor 152 | 10 | kΩ |
| Fourth resistor 162 | 1 | kΩ |
| Fifth resistor 168 | 10 | kΩ |
| First capacitor 156 | 1 | μF |
| Second capacitor 158 | 0.1 | μF |
| Third capacitor 166 | 0.1 | μF |
| DC voltage source 170 | 5 | V |

While the foregoing description has been provided with reference to a switching isolated power supply encompassing a flyback transformer, it is readily understood that the broader aspects of the present invention are suitable for other types of switching power supplies, such as buck, boost, buck-boost, forward, half bridge and full bridge circuits. Additionally, switching power supplies incorporating an inductor may also utilize the broader aspects of this invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for determining an input voltage in an isolated switching power supply, the method comprising:
detecting a peak-to-peak voltage in an output side of the power supply at a point in a circuit topology of the output side where the peak-to-peak voltage correlates to the input voltage; and
determining the input voltage from the detected peak-to-peak voltage.

2. The method of claim 1 wherein the peak-to-peak voltage comprises a positive pulse and a negative pulse.

3. The method of claim 2 wherein determining the input voltage further comprises combining the positive pulse and negative pulse into a positive DC pulse voltage.

4. The method of claim 3 wherein determining the input voltage further comprises adjusting the positive DC voltage pulse using a voltage divider circuit to form a reduced-positive DC voltage pulse proportional to the input voltage.

5. The method of claim 4 wherein determining the input voltage further comprises conducting a charging operation on the reduced-positive voltage pulse in order to maintain a constant-positive DC voltage.

6. The method of claim 5 wherein determining the input voltage further comprises measuring the constant-positive DC voltage.

7. The method of claim 1 wherein detecting the peak-to-peak voltage in the output side of the power supply further comprises detecting the peak-to-peak voltage at a secondary side of a transformer of the power supply.

8. The method of claim 1 wherein detecting the peak-to-peak voltage in the output side of the power supply further comprises detecting the peak-to-peak voltage in an output side of a flyback circuit, a buck circuit, a boost circuit, a buck-boost circuit, a forward circuit, a half bridge circuit and a full bridge circuit.

9. The method of claim 1 wherein determining the input voltage further comprises transforming the peak-to-peak voltage into a constant DC positive voltage.

10. The method of claim 1 further comprising storing and retrieving a determined AC input voltage.

11. The method of claim 1 further comprising determining a rate of change from a previously determined input voltage compared to a newly determined AC input voltage.

12. The method of claim 1 further comprising determining an over-voltage condition, wherein the over-voltage condition is indicative of a determined AC input voltage above a predetermined maximum threshold.

13. The method of claim 1 further comprising determining an under-voltage condition, wherein the under-voltage condition is indicative of a determined AC input voltage below a predetermined minimum threshold.

14. The method of claim 1 further comprising determining a power out condition on the input side of the power supply, wherein the power-out condition is indicative of a nearly zero and zero voltage level.

15. A system for determining an AC input voltage in a switching isolated power supply, the system comprising:
a power source supplying an input voltage;
an isolated switching power supply coupled to the power source and operative to receive the input voltage, where the isolated switching power supply produces a peak-to-peak voltage correlated to the input voltage;
a conversion module coupled to the isolated switching power supply and operative to detect the peak-to-peak voltage in an output side of the power supply at a point in a circuit topology of the output side where the peak-to-peak voltage correlates to the input voltage; and,
a sampling module coupled to the conversion module and operative to determine the input voltage from the detected peak-to-peak voltage.

16. The system of claim 15 wherein the peak-to-peak voltage comprises a positive pulse and a negative pulse.

17. The system of claim 16 wherein the conversion module further comprises a charging module operative to combine the positive pulse and the negative pulse into a positive DC pulse voltage.

18. The system of claim 17 wherein the conversion module further comprises a voltage reduction module operative to receive the positive DC pulse voltage and scale the positive DC pulse voltage into a reduced DC positive pulse voltage that is proportional to the input voltage.

19. The system of claim 18 wherein the conversion module further comprises a regulator module operative to perform a charging operation such that the reduced DC positive peak voltage is transformed into a constant-positive DC voltage.

20. The system of claim 19 wherein the sampling module measures the constant-positive DC voltage and determines the input voltage based on a measured constant-positive DC voltage.

21. The system of claim 20 wherein the sampling module discharges the regulator module prior to measuring the constant-positive DC voltage.

22. The system of claim 19 further comprising an operating module coupled to the sampling module and operative to receive a computed input voltage, wherein the operating module stores and retrieves the computed input voltage.

23. The system of claim 19 further comprising an operating module coupled to the sampling module and operative to receive a determined input voltage, wherein the operating module protects a subsystem and a component from over-voltage conditions, wherein the operating module determines a measured constant DC voltage is above of a predetermined maximum threshold.

24. The system of claim 19 further comprising an operating module coupled to the sampling module and operative to shut down a system, a subsystem and a component from an under-voltage condition to minimize harm and protect the system, the subsystem and the component, wherein the operating module determines a measured constant DC voltage is below a predetermined minimum threshold.

25. The system of claim 19 wherein the operating module is further operative to shut down a motor when the determined input voltage is below the minimum threshold.

26. The system of claim 15 wherein the conversion module is operative to detect the peak-to-peak voltage in the output side of the isolated switching power supply further comprises the conversion module operative to detect the peak to peak voltage in a secondary side of a transformer of the isolated switching power supply.

27. The system of claim 15 wherein the conversion module is operative to detect the peak-to-peak voltage in the output side of the isolated switching power supply further comprises the conversion module operative to detect the peak to peak voltage in an output side of a flyback circuit, a buck circuit, a boost circuit, a buck-boost circuit, a forward circuit, a half bridge circuit and a full bridge circuit.

28. A method for determining an input voltage in an isolated switching power supply, the method comprising:
detecting a peak-to-peak voltage in an output side of the power supply at a point in a circuit topology of the output side where the peak-to-peak voltage correlates to an input voltage applied to the input side of the power supply, wherein the peak-to-peak voltage alternates between a negative pulse and a positive pulse; and
generating a constant DC voltage based on a function of whether the peak-to-peak voltage is below a predetermined threshold.

29. The method of claim 17 further comprising sinking the constant DC voltage to ground as the peak-to-peak voltage exceeds the predetermined threshold.

30. The method of claim 18 wherein sinking the constant DC voltage to ground further comprises cycling a switch from OFF to ON to provide a path for the constant-positive voltage to travel to ground, wherein the peak-to-peak voltage exceeds the threshold.

31. The method of claim 17 wherein detecting the peak-to-peak voltage in the output side of the flyback circuit further comprises detecting a peak-to-peak voltage in a secondary side of a flyback transformer.

32. The method of claim 17 further comprising generating an indicator to notify a user when the peak-to-peak voltage is above the threshold.
